(19) United States
(12) Patent Application Publication
(10) Pub. No.: US 2008/0003146 A1
(43) Pub. Date: Jan. 3, 2008

(54) Sample pad system for controlling fluid movement between a sample receiving pad and a test strip

(76) Inventors: Urs A. Ramel, Sunnyvale, CA (US); Dillan Tay, San Jose, CA (US)

Correspondence Address: BAYER;LERNER, DAVID, LITTENBERG, KRUMHOLZ & MENTLIK, LLP, 600 South Avenue West, Westfield, NJ, 07090, US

(21) Appl. No.: 11/810,424

(22) Filed: Jun. 5, 2007

Related U.S. Application Data
(60) Provisional application No. 60/811,880, filed on Jun. 7, 2006.

(51) Int. Cl. B01L 3/00

(52) U.S. Cl. 422/100

(57) ABSTRACT

A system for controlling fluid flow movement between a sample receiving pad and a test strip, including: a sample receiving pad having first and second portions separated by a narrowed portion; an absorbent pad in contact with the first portion of the sample receiving pad; and a test strip in contact with the second portion of the sample receiving pad.

### RELATED APPLICATION

The present application claims priority to U.S. Provisional Patent Application 60/811,880, entitled “Sample Pad System For Controlling Fluid Movement Between A Sample Receiving Pad and Test Strip”, filed Jun. 6, 2006.

### TECHNICAL FIELD

The present invention relates to fluid flow control systems in test meters.

### SUMMARY OF THE INVENTION

The present invention provides a system for controlling fluid flow movement between a sample receiving pad and a test strip, comprising: a sample receiving pad having first and second portions separated by a narrowed portion; an absorbent pad in contact with the first portion of the sample receiving pad; and a test strip in contact with the second portion of the sample receiving pad.

The present invention is provides novel patentable improvements to the system shown in U.S. patent application Ser. No. 11/121,972, entitled “Mechanical cartridge with test strip fluid control features for use in a fluid analyte meter”, filed May 4, 2005. As such, the present application is related to, but does not claim priority to U.S. patent application Ser. No. 11/121,972.

In various aspects, the absorbent pad is in overlapping contact with the first portion of the sample receiving pad. For example, the absorbent pad may be positioned on top of (or under) the first portion of the sample receiving pad. An end of the test strip may overlap the second portion of the sample receiving pad.

In various aspects, the sample receiving pad, absorbent pad and test strip are all disposed in a cartridge, and the cartridge has a sample receiving hole positioned over the second portion of the sample receiving pad.

In various aspects, the second portion of the sample receiving pad has an inwardly curved rear edge adjacent to the narrowed portion of the sample receiving pad separating the first and second portions of the sample receiving pad.

In various aspects, the cartridge comprises a pinch wall compressing the sample receiving pad. The pinch wall may optionally comprise: a first portion separating a sample receiving portion of the sample receiving pad from a portion of the sample receiving pad positioned away from the test strip, and a second portion separating the sample receiving portion of the sample receiving pad from a portion of the sample receiving pad positioned adjacent to the test strip, wherein the second portion of the pinch wall compresses the sample receiving pad to a lesser degree than the first portion of the sample receiving pad.

In various aspects, the first and second portions of the pinch wall together continuously surround the sample receiving portion of the sample receiving pad. The pinch wall may preferably compress the sample receiving pad such that fluid received onto the sample receiving pad preferentially tends to flow from the sample receiving portion of the sample receiving pad into the portion of the sample receiving pad positioned adjacent to the test strip, and less so from the sample receiving portion of the sample receiving pad to the portion of the sample receiving pad positioned away from the test strip.

In optional aspects, the first portion of the pinch wall compresses 60 to 90% of the height of the sample receiving pad and the second portion of the pinch wall compresses 2 to 30% of the height of the sample receiving pad. In other optional aspects, the first portion of the pinch wall compresses 70 to 80% of the height of the sample receiving pad and the second portion of the pinch wall compresses 5 to 15% of the height of the sample receiving pad.

In optional aspects, the first portion of the pinch wall comprises a notch adjacent to the absorbent pad to permit fluid flow into the absorbent pad.

### BRIEF DESCRIPTION OF THE DRAWINGS

FIG. 1 is an exploded perspective view of the system as seen in U.S. patent application Ser. No. 11/121,972.

FIG. 2 is an exploded perspective view of the present invention, showing novel changes made to the design of FIG. 1.

FIG. 3 is an exploded perspective view of the system of the underside of the cartridge top as seen in U.S. patent application Ser. No. 11/121,972.

FIG. 4 is an exploded perspective view of the present invention of the underside of the cartridge top, showing novel changes made to the design of FIG. 3.

FIG. 5 is a an exploded perspective view of the system of the top of the cartridge bottom as seen in U.S. patent application Ser. No. 11/121,972.

FIG. 6 is an exploded perspective view of the present invention of the top of the cartridge bottom, showing novel changes made to the design of FIG. 5.

FIG. 7 is perspective illustration of the present invention.

### DETAILED DESCRIPTION OF THE DRAWINGS

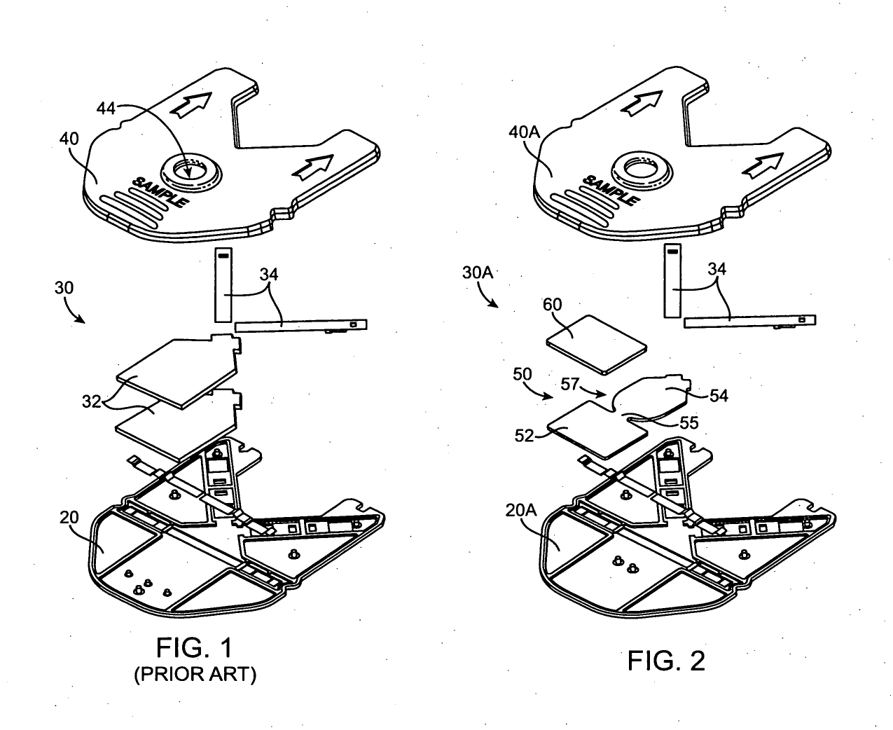

Embodiments of the system as set forth in U.S. patent application Ser. No. 11/121,972 are seen in FIGS. 1, 3 and 5. The patentable novel improvements included in the present invention are seen in FIGS. 2, 4, 6 and 7.

FIG. 1 shows a system 30 having a cartridge top 40 and bottom 20. One or more sample receiving pads 32 are disposed under sample receiving hole 44 in cartridge top 40.

FIG. 2 illustrates the present invention in which a system 30A for controlling fluid flow movement between a sample receiving pad and a test strip is provided. This system includes a sample receiving pad 50 having first and second portions (52 and 54) separated by a narrowed portion 55. An absorbent pad 60 is in contact with first portion 52 of sample receiving pad 50. A test strip (or test strips) 34 is in contact with second portion 54 of sample receiving pad 50, as shown. In one embodiment, an end of test strip(s) 34 overlaps second portion 54 of sample receiving pad 50.

Preferably, absorbent pad 60 is in overlapping contact with first portion 52 of sample receiving pad 50. For example, absorbent pad 60 may be positioned on top of first portion 52 of sample receiving pad 50. Sample receiving pad 50, absorbent pad 60 and test strip(s) 34 may all be disposed in a cartridge, as shown.

In an optional aspect, second portion 54 of sample receiving pad 50 may have an inwardly curved rear edge 57 adjacent to narrowed portion 55 of sample receiving pad 50 that separates first and second portions 52 and 54.

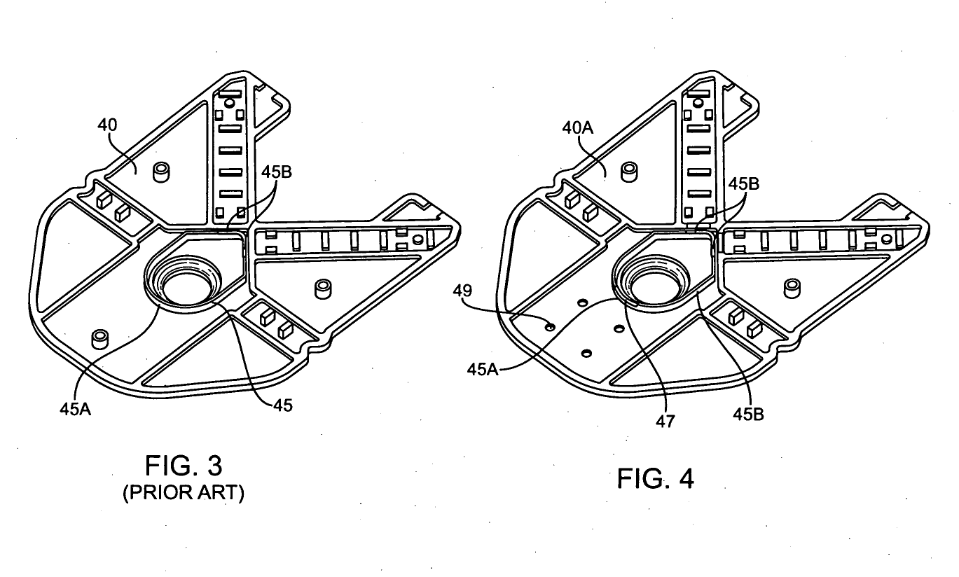

FIG. 3 shows the system of the underside of the cartridge top 40 as seen in U.S. patent application Ser. No. 11/121,972. A pinch wall 45 (comprising first portion 45A and second portion 45B) is provided.

FIG. 4 illustrates the present invention in which cartridge top 40A also has a pinch wall 45 (comprising first portion 45A and second portion 45B). Similar to the embodiment shown in FIG. 3, pinch wall 45 compresses sample receiving pad 50. In addition, pinch wall 45 pay comprise: a first portion 45A separating a sample receiving portion of the sample receiving pad 50 from a portion of the sample receiving pad 50 positioned away from test strip(s) 34, and a second portion 45B separating the sample receiving portion of the sample receiving pad 50 from a portion of the sample receiving pad 50 positioned adjacent to test strip(s) 34, wherein second portion 45B of the pinch wall compresses the sample receiving pad to a lesser degree than the first portion 45A of sample receiving pad 50.

As such, pinch wall 45 compresses the sample receiving pad 50 such that fluid received onto the sample receiving pad 50 preferentially tends to flow from the sample receiving portion of the sample receiving pad into the portion of the sample receiving pad positioned adjacent to test strip(s) 34, and less so from the sample receiving portion of the sample receiving pad 50 to the portion of the sample receiving pad positioned away from test strip(s) 34.

In optional aspects, first portion 45A of the pinch wall compresses 60 to 90% of the height of the sample receiving pad 50 and second portion 45B of the pinch wall compresses 2 to 30% of the height of the sample receiving pad. In other optional aspects, the first portion 45A of the pinch wall compresses 70 to 80% of the height of the sample receiving pad 50 and the second portion 45B of the pinch wall compresses 5 to 15% of the height of the sample receiving pad 50.

In accordance with the present invention, pinch wall portion 45A includes a notch 47. Notch 47 permits fluid to flow directly into absorbent pad 60. Thus, any excess fluid sample sitting on top of second portion 54 can be absorbed directly into absorbent pad 60. This feature of the invention helps to ensure that test strips 34 do not become flooded. Thus, excess sample volumes can be adequately handled (i.e.: by increasing the overflow capacity of the device).

As can also be seen in FIG. 4, optional wick pad compression dimples 49 can be used to hold absorbent pad 60 in place.

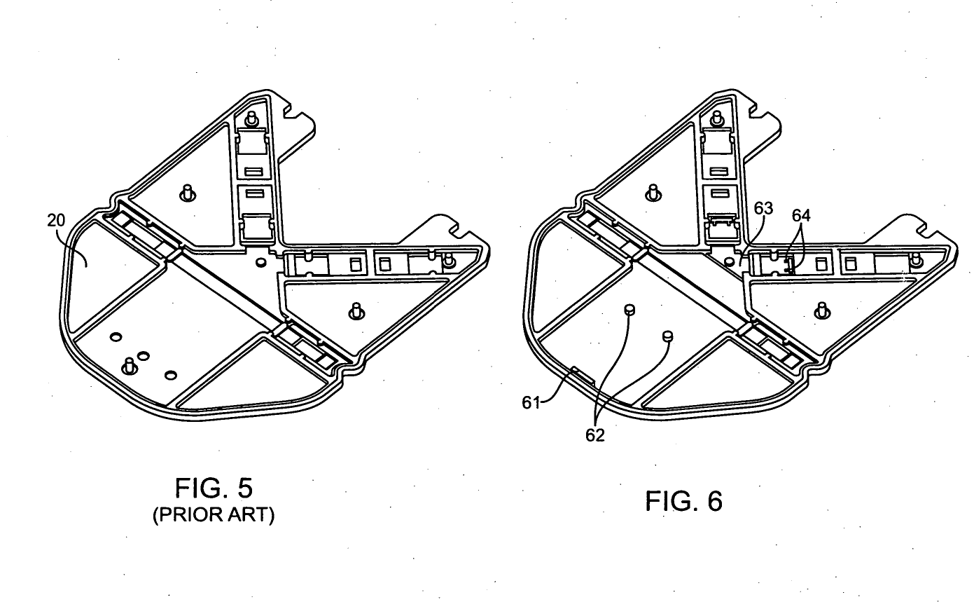

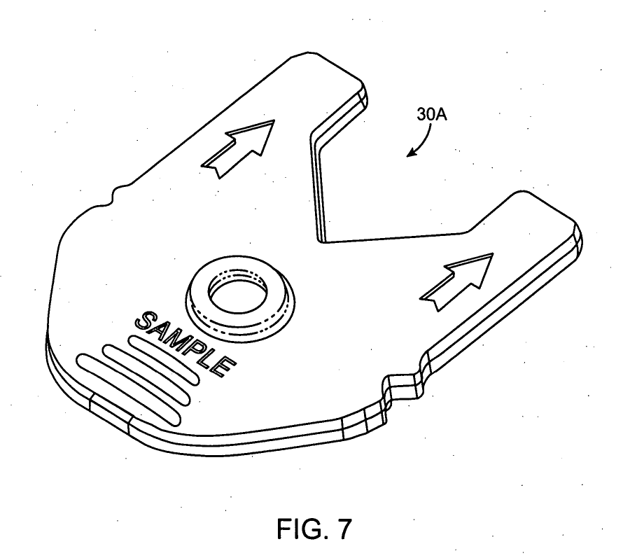

FIG. 5 shows the system of the top of the cartridge bottom 20 as seen in U.S. patent application Ser. No. 11/121,972. FIG. 6 illustrates optional features of the present invention including a wick pad positioning wall 61 and sample pad positioning pins 62 that can be used to hold absorbent pad 60 in place. Also included are a raised sample pad floor 63 which advantageously permits smaller amounts of fluid to be used in the present invention (without flooding test strip(s) 34). Also included are strip ramps 64 for positioning test strip(s) 34.

Lastly, FIG. 7 illustrates a view through assembled system 30A.

What is claimed is:

1. A system for controlling fluid flow movement between a sample receiving pad and a test strip, comprising:
a sample receiving pad having first and second portions separated by a narrowed portion;
an absorbent pad in contact with the first portion of the sample receiving pad; and
a test strip in contact with the second portion of the sample receiving pad.

2. The system of claim 1, wherein the absorbent pad is in overlapping contact with the first portion of the sample receiving pad.

3. The system of claim 2, wherein the absorbent pad is positioned on top of the first portion of the sample receiving pad.

4. The system of claim 1, wherein the sample receiving pad, absorbent pad and test strip are all disposed in a cartridge.

5. The system of claim 4, wherein the cartridge comprises a body having a sample receiving hole positioned over the second portion of the sample receiving pad.

6. The system of claim 1, wherein an end of the test strip overlaps the second portion of the sample receiving pad.

7. The system of claim 1, wherein the second portion of the sample receiving pad has an inwardly curved rear edge adjacent to the narrowed portion of the sample receiving pad separating the first and second portions.

8. The system of claim 1, further comprising:
a second test strip in contact with the second portion of the sample receiving pad.

9. The system of claim 4, wherein the cartridge comprises a pinch wall compressing the sample receiving pad.

10. The system of claim 9, wherein the pinch wall comprises:
a first portion separating a sample receiving portion of the sample receiving pad from a portion of the sample receiving pad positioned away from the test strip, and
a second portion separating the sample receiving portion of the sample receiving pad from a portion of the sample receiving pad positioned adjacent to the test strip, wherein the second portion of the pinch wall compresses the sample receiving pad to a lesser degree than the first portion of the sample receiving pad.

11. The system of claim 10, wherein the first and second portions of the pinch wall together continuously surround the sample receiving portion of the sample receiving pad.

12. The system of claim 10, wherein the pinch wall compresses the sample receiving pad such that fluid received onto the sample receiving pad preferentially tends to flow from the sample receiving portion of the sample receiving pad into the portion of the sample receiving pad positioned adjacent to the test strip, and less so from the sample receiving portion of the sample receiving pad to the portion of the sample receiving pad positioned away from the test strip.

13. The system of claim 10, wherein the first portion of the pinch wall compresses 60 to 90% of the height of the sample receiving pad and the second portion of the pinch wall compresses 2 to 30% of the height of the sample receiving pad.

14. The system of claim 10, wherein the first portion of the pinch wall compresses 70 to 80% of the height of the sample receiving pad and the second portion of the pinch wall compresses 5 to 15% of the height of the sample receiving pad.

15. The system of claim 10, wherein the first portion of the pinch wall comprises a notch adjacent to the absorbent pad to permit fluid flow into the absorbent pad.
